(19) United States
(12) Patent Application Publication
(10) Pub. No.: US 2003/0048775 A1
(43) Pub. Date: Mar. 13, 2003

(54) Method for routing data packets

(75) Inventor: Robert Westermeier, Sauerlach (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/234,844

(22) Filed: Sep. 5, 2002

(30) Foreign Application Priority Data
Sep. 10, 2001 (DE) 101 44 356.0

(51) Int. Cl. H04L 12/66; H04L 12/28

(52) U.S. Cl. 370/352; 370/401

(57) ABSTRACT

Data packets are routed in at least one packet-switched network with a number of communication networks connected to the packet-switched network via gateways. Location data to be transmitted between communication networks is routed based on the communication protocols used in the respective communication networks.

### CROSS REFERENCE TO RELATED APPLICATIONS

This application is based on and hereby claims priority to German Application No. 101 44 356.0 filed on Sep. 10, 2001, the contents of which are hereby incorporated by reference.

### BACKGROUND OF THE INVENTION

1. Field of the Invention

The invention relates to a method for routing data packets in a packet-switched network.

2. Description of the Related Art

In present day telecommunication networks, communication links are mainly implemented as connection-oriented links. In such a connection-orientated communication link, only one dedicated “line”, which is reserved for this communication link, is provided for the signal transmission between two communication end points. Although this is no physically reserved line in an existing communication link in modern communication facilities implementing switching from associated communication end points, communication links which are familiar to the expert as “time slot oriented” are also included in the connection-oriented communication links in the literature.

An alternative to the connection-oriented communication link mentioned initially is a packet-switched communication link. With the increasing expansion of packet-switched networks such as, for example, the Internet or of spatially limited networks—often called local area networks, (LAN) in the technical world—a more economic variant of a telecommunication infrastructure in comparison with a connection-oriented communication network is possible in many cases. This is also based on a better efficiency of utilization of available connection resources since, e.g. transmission capacities can be used much more efficiently by a packet-switched transmission than is possible in the case of a connection-oriented transmission with assured line capacity.

In packet-switched communication networks, the switching of communication partners is not administered by a central communication facility. Instead, the communication link is maintained by alternately transmitting and receiving data packets, containing user information and signalling information, between the two communication partners, the individual data packets containing, among other things, information on the destination address of the other communication partner in each case.

This type of communication links via packet-switched networks—often called “voice over IP, (VoIP) in the technical world—is based in many cases on the protocols for data communication via the Internet known in the technical world, particularly the so-called “Internet Protocol”, abbreviated “IP”. The protocols H.323 and, respectively, SIP (Session Initiation Protocol) are widely used for VoIP communication.

SIP is a signalling protocol for Internet telephony and for other services such as conference interactions, event notification, message transmission etc. This protocol has been developed by the working group MMUSIC (Multiparty Multimedia Session Control) of the working group IETF (Internet Engineering Task Force).

The H.323 standard is an international ITU-T (International Telecommunication Union—Telecommunications Standardization Sector) standard for voice, data and video communication via packet-switched networks which guarantees interoperability between the manufacturers' products, defining among other things system components such as communication end points, gateway facilities and a central control computer which, among other things, determines the route—often called gatekeeper—for a communication system according to this standard.

A communication end point (terminal) is a communication end point designed in accordance with the H.323 or SIP standards.

A gateway facility (or gateway) is understood to be a hardware or software configuration which handles the interconnection of different networks. A gateway thus has the task of transmitting data packets from one network into another one which requires, above all, a conversion between the communication protocols used in the connected networks. This conversion can also be done, in particular, in a protocol which does not operate in accordance with the principle of packet switching, for example an ISDN (Integrated Services Digital Network) protocol. In this way, gateways are frequently arranged between a packet-switched network—for example a LAN—and a communication facility such as, for example, a switching system operating in accordance with a time slot oriented method—often called private branch exchange (PBX) in the technical world.

The central master computer for determining the routing, finally, is a central control unit which controls, among other things, the routing, the call signalling and the allocation of directory numbers and IP addresses of the communication network or, respectively, their conversion. In the text which follows, the function of determining the routing is called a routing server. This routing server is also responsible for authorizing access to the communication network.

The routing of a routing server is not only restricted to the exchange of signalling information but includes all data packets exchanged between communication end points of a communication network, that is to say also data packets which contain actual user information (such as, e.g. voice or video data).

In many applications, a packet-switched network contains a number of interfaces—connected by gateways—to communication facilities operating in a connection-oriented manner. These administer a communication network which operates, for example, in accordance with the ISDN protocol.

The ISDN protocol is characterized by separating user information—e.g. voice or video communication data—into one or more so-called B channels and signalling information into a so-called D channel. The signalling information contains data for connection control, signalling etc. Moreover, in modern communication systems, other data, among other things, are also transmitted on the D channel which provide for extended features such as, for example, a display of the name and other information of a calling or called subscriber at the communication end point of a called or calling subscriber, respectively.

Accordingly, the signalling information of the ISDN protocol has many different variants, only three familiar ones of which—the QSIG (Q Interface SIGNALing) protocol, the DSS1 (Digital Subscriber System No. 1) protocol and the 1TR6 (Technical Guideline of Deutsche Telekom)—will be described in the text which follows. In addition, there is a multiplicity of other proprietary ISDN protocols which are used by manufacturers of communication facilities.

The QSIG protocol is an international signalling standard, defined by the ECMA (European Computer Manufacturers Association) for logical signalling between two private switching nodes, e.g. communication facilities. QSIG exhibits a few generic functions to which other features can be added. These can be both purely QSIG-compliant, QSIG-compliant with proprietary extensions and proprietary.

The DSS1 protocol is a European ISDN protocol for the D channel of the European Euro-ISDN, based on ITU-T (International Telecommunication Union) I.411. The DSS1 protocol replaces the 1TR6 protocol used by Deutsche Telecom.

The 1TR6 protocol is a national ISDN protocol for the D channel of Deutsche Telecom. This technical guideline is being revised to the abovementioned European DSS1 protocol in the course of European harmonization. The differences between the two protocols are found in, among other things, the transmission of the directory number information. Furthermore, in the 1TR6 protocol, all communication end points at an ISDN basic access can have both an identical directory number and be addressed individually by a communication end point selection digit.

In ITU-T Recommendation H.225.0, November 200 version, Section 7.3 (Q.931 Message Details), an information element “desired protocols” is disclosed in subpoint 7.3.10 (set up), which specifies a preferred protocol type (e.g. voice communication or fax exchange) between a communication partner initiating the communication and a called communication partner. Using this information element, an executing entity can locate a communication partner which also supports this protocol type.

Whereas the signals of user and signalling information are transmitted time-continuously in traditional ISDN based communication systems, VoIP-based communication systems require the signals to be split into individual data packets provided with destination addresses in order to transmit the data of the user and signalling information via a packet-switched network. When they leave the packet-switched network, the data packets are assembled again into a continuous data stream. In association with this packet assembly and disassembly, tunnelling is often mentioned. Tunnelling is generally understood to be a transport of signalling information present in a first protocol within a second protocol of a different type.

Routing of these tunnelled data packets is handled by, among other things, the routing server. In routing data packets, the routing server generally determines the most efficient path through the packet-switched network with respect to an achievable quality of transmission.

In a communication link between two communication facilities connected to a packet-switched network via gateways, the problem frequently occurs that the two communication facilities operate with different communication protocols. This inequality of protocols can be bypassed by restricting oneself to basic call functions which, however, entails the loss of features

### SUMMARY OF THE INVENTION

It is an object of the invention to specify a method for routing in which the full bandwidth of features provided by the communication facilities is retained between two communication partners.

According to the invention, the communication protocols used in the communication networks are taken into consideration in the routing of data packets exchanged between two communication end points, arranged within different communication networks, via a packet-switched network.

An essential advantage of the method according to the invention can be seen in that, due to the fact that the communication protocols are taken into consideration in the routing, the switching is transparent to features. Feature transparency means that a connection between two communication end points using identical or similar communication protocols can be effected by an unconverted exchange of signalling information. Accordingly, the same bandwidth of features as in a connection internal to the communication network is available at the communication end points.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of communication networks connected by a packet-switched network.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

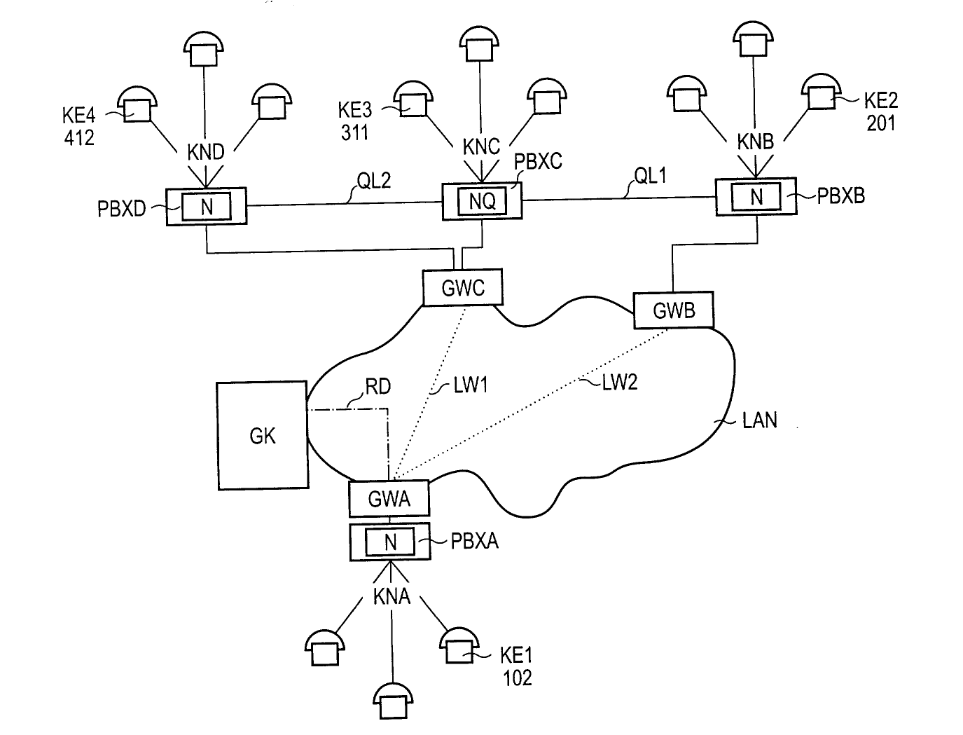

FIG. 1 shows four communication networks KNA, KNB, KNC which are formed by a respective associated central communication facility PBXA, PBXB, PBXC, PBXD and a number of communication end points. The communication networks KNA, KNB, KNC operate, for example, on the basis of an ISDN protocol.

To simplify the reference, only one communication end point is in each case provided with a reference symbol in each communication network KNA, KNB, KNC, KND. A first communication end point KE1 in the first communication network KNA is identified by a directory number “102”, a second communication end point KE2 in the second communication network KNB is identified by the directory number “201”, a third communication end point KE3 in the third communication network KNC is identified by the directory number “311” and a fourth communication end point KE4 in the fourth communication network KND is identified by the directory number “412”.

The first, second and fourth communication facilities PBXA, PBXB, PBXD operate with a first communication protocol N whereas the third communication facility PBXC operates with a second communication protocol NQ differing from the first communication protocol N. These communication protocols N, NQ are implemented, for example, in a switching and feature controller of the respective communication facility PBXA, PBXB, PBXC. The implementation of the communication protocols N; NQ in the respective communication facility PBXA, PBXB, PBXD; PBXC affects the format of the signalling information in the respective communication network KNA, KNB, KND; KNC and may thus also influence the software or hardware design of the communication end points existing in the respective communication network KNA, KNB, KND; KNC. A communication link between two communication end points with identical communication protocol is generally called a feature-transparent communication link since in this case the same features are available with identical signalling information at both communication end points when the respective feature is called up.

The first and second communication facilities PBXA, PBXB are connected to a packet-switched network LAN via a respective associated gateway GWA, GWB. The third and fourth communication facilities PBXC, PBXD are connected to the packet-switched network LAN via a common gateway GWC. Allocating the first two communication facilities PBXA, PBXB to in each case one gateway GWA, GWB has been done for a simplified representation whereas, in technical practice, a number of communication facilities is frequently connected to one gateway—analogously to the communication facilities PBXC, PBXD jointly connected to the gateway GWC.

The second and third communication facilities PBXB, PBXC and a third and fourth communication facilities PBXC, PBXD are in each case connected to one another via interconnection lines QL1, QL2. Using the interconnection line QL1, e.g., it is possible to connect the second communication end point KE2 to the third communication end point KE3 without using a route via the packet-switched network LAN. These interconnection lines QL1, QL2 should be considered as an example of a more extensive—more complex and more closely meshed, in reality—networking of communication facilities.

Whereas communication data are transmitted time-continuously in the ISDN-based communication networks KNA, KNB, KNC, KND, tunnelling of the communication data is necessary via the packet-switched network LAN. For this purpose, the time-continuous communication data are split into individual data packets and the destinations of these data packets are addressed with the IP (Internet Protocol) number of the connected communication end point and—in the reverse direction—from the packet-switched network LAN in the direction of one of the communication networks KNY, KNB, KNC, KND—the data packets intended for the communication end point arranged in the respective communication network KNY, KNB, KNC, KND are converted into a time-continuous data stream, among other things. This splitting-up is performed by the gateways GWA, GWB, GWC.

In a routing server GK connected to the packet-switched network LAN—a central server unit—an optimized routing—determined in accordance with aspects of traffic theory, with quality of connection etc.—of the data packets is determined which are exchanged between the respective gateways GWA, GWB, GWC. For this purpose, the respective gateway GWA, GWB, GWC—shown dot-dashed for the first gateway GWA in the drawing—exchanges data packets containing information in conjunction with the routing, so-called routing data RD, bi-directionally with the routing server GK.

The communication facilities PBA, PBB, PBC, PBXD operate in accordance with a time slot oriented switching principle—often called time division multiplex (TDM) in the technical world—and control the connected communication end points via signalling information.

In the text which follows, it will be assumed that a communication link is to be set up between the first and third communication end point KE1, KE3.

As illustrated by dotted lines in FIG. 1, a first route LW1 connects the first and third gateway GWA, GWC and a second route LW2 connects the first and the second gateway GWA, GWB. Showing the routes LW1, LW2 with dotted lines is restricted to the packet-switched network LAN for reasons of clarity. The routes LW1, LW2 extend to the communication facility PBXA, PBXB, PBXC, PBXD belonging to the connected communication end point, starting from the communication facility PBXA, PBXB, PBXC, PBXD belonging to a communication end point. Furthermore, the representation of the routes LW1, LW2 does not illustrate the actual topological path of individual data packets for the packet-switched network LAN but the connection between two communication partners. The two routes LW1, LW2 are determined by the routing server GK with a previous exchange of routing data RD with the first gateway GWA. The second and third gateway also exchange routing data RD (not shown) with the routing server GK.

Using the first route LW1, tunnelled communication data containing signalling and user information are exchanged directly between gateways GWA, GWC belonging to the first and third communication end point KE1, KE3. At the third gateway GWB, these tunnelled communication data are converted into time-continuous user and signalling information and transferred to the third communication end point KE3 via the third communication system PBXC. In the reverse direction, time-continuous user and signalling information from the third communication facility PBXC is transmitted from the third communication end point KE3 to the third gateway GW3 and from the latter, tunnelled in the form of data packets, via the packet-switched network LAN to the first gateway GWA. Since the two communication protocols N, NQ are not compliant with one another, this choice of routing by the routing server GK does not result in feature transparency in the communication link between the first and third communication end point KE1, KE3 since the signalling information used by the first and third communication facilities GWA, GWC is not compatible.

When the second route LW2 is used, tunnelled, communication data containing signalling and user information is first exchanged between the first and second gateway GWA, GWB. At the second gateway GWB, these tunnelled communication data are converted back into time-continuous user and signalling information and transferred to the second communication facility PBXB. There they are converted by an interface, not shown, into a signalling information format, the basic communication protocol of which is also implemented at an interface of similar format, not shown, in the third communication facility PBXC. The communication data are exchanged bi-directionally between the two communication facilities PBXB, PBXC via an interconnection line QL. At the communication facility PBXC, the communication data received via the interconnection line QL are converted into the local communication protocol NQ and transferred to the third communication end point KE3. The corresponding conversions are effected analogously in the opposite direction.

Choosing the second route LW2 for the data packets exchanged between the first and the third communication end point KE1, KE3 thus results in a feature-transparent communication link between the communication end points KE1 and KE3.

The route LW2 resulting in a feature-transparent communication link is determined by the routing server GK. A routing server administers information for routing data packets which takes into consideration data of routing tables stored in the routing server. According to the invention, these routing tables contain an entry about the implemented communication protocols of the communication facilities connected to the destination gateway GWC, in the case of PBXC. A route LW2 which, in the case of a communication link between two communication end points KE1, KE3 via gateways GWA, GWB interconnects two communication facilities PBXA, PBXB having identical—or also similar with respect to the format of their signalling information—communication protocols and in this manner provides for a feature-transparent communication link, which has higher priority than other criteria such as transmission capacity, quality of transmission etc.

Using the bidirectional exchange of routing data RD between the routing server GK and the gateways GWA, GWB, GWC—in the drawing, this exchange is only shown with the example of the first gateway GWA for reasons of clarity—a feature-transparent connection of the first communication end point KE1 to the third communication end point KE3 can also be implemented via the first route LW1 shown in the drawing, via the first and third gateway GWA, GWC, the fourth communication facility PBXD and via the interconnection line QL2 to the third communication facility PBXC. The routing according to the invention is not restricted only to the routing of data packets via the packet-switched network LAN to their destination but also influences the routing of the continuous data stream—converted from data packets in the respective gateway GWA, GWB, GWC—to its destination. The routing data RD exchanged between the routing server GK and the first and third gateway GWA, GWC respectively—only shown between the first gateway GWA and the routing server GK in the drawing—contain an information item for the transmission of the data stream converted from the data packets from the third gateway GWC to the fourth communication facility PBXD and vice versa for this alternative first route LW1. The fourth communication facility has a communication protocol N which is identical to the first communication facility PBXA. Using the alternative first route LW1, a feature-transparent connection between the first communication end point KE1 and the third communication end point KE3 can thus be implemented via the interconnection line QL2 analogously to the second route LW2—in this case via the interconnection line QL1.

The methods for routing data packets as described can also be implemented without involving a routing server GK in so far as parts of its functions are carried out by a correspondingly designed gateway e.g. by the first gateway GWA.

The invention has been described in detail with particular reference to preferred embodiments thereof and examples, but it will be understood that variations and modifications can be effected within the spirit and scope of the invention.

What is claimed is:

1. A method for routing communication data via at least one packet-switched network with communication networks connected to the packet-switched network via at least first and second gateways, comprising:
routing communication data between the communication networks taking into consideration communication protocols used in respective communication networks.

2. The method as claimed in claim 1, wherein said routing is carried out by a central routing server controlling the gateways.

3. The method as claimed in claim 2, further comprising administrating routing tables containing data for at least one of dynamic and static routing in the central routing server.

4. The method as claimed in claim 3, wherein the routing tables contain an entry characterizing the communication protocols used in the communication networks.

5. The method as claimed in claim 4, wherein said routing includes
starting from a first communication end point connected to a first communication network;
ending at a second communication end point connected to a second communication network; and
routing directly from the first gateway via the packet-switched network to the second gateway allocated to the second communication network, the communication protocols of the first and second communication networks being substantially identical.

6. The method as claimed in claim 4, wherein said routing includes
starting from a first communication end point connected to a first communication network having a first communication protocol;
ending at a second communication end point connected to a second communication network having a second communication protocol different from the first communication protocol;
routing via the packet-switched network from the first communication network to a third communication network having a third communication protocol at least similar to the first communication protocol, and
subsequent to said routing to the third communication network, establishing an interconnection line from the third communication network to the second communication network.

7. The method as claimed in claim 6, wherein said routing passes through gateways, using information from at least one of the central routing server and transmitted data packets.

8. The method as claimed in claim 7, wherein said routing includes controlling the communication networks by communication facilities.

9. The method as claimed in claim 8, further comprising tunnelling communication data of the communication networks via the packet-switched network.

10. The method as claimed in claim 9, wherein respective gateways are connected to a corresponding communication network via at least one associated communication facility.

11. The method as claimed in claim 10, wherein the communication protocols correspond to ISDN-oriented standards.

12. The method as claimed in claim 11, wherein the communication data in the packet-switched network are data packets structured according to a Voice Over IP standard.

13. The method as claimed in claim 12, wherein the data packets are structured in accordance with the H.323 standard.

14. The method as claimed in claim 12, wherein the data packets are structured in accordance with the SIP standard.

15. The method as claimed in claim 14, further comprising giving higher priority to said routing between the communication networks having at least similar communication protocols.

16. A system for routing communication data via at least one packet-switched network with communication networks connected to the packet-switched network via at least first and second gateways, comprising:
at least one processor programmed to route communication data between the communication networks taking into consideration communication protocols used in respective communication networks.

17. At least one computer readable medium storing at least one program for controlling at least one processor to perform a method for routing communication data via at least one packet-switched network with communication networks connected to the packet-switched network via at least first and second gateways, comprising:
routing communication data between the communication networks taking into consideration communication protocols used in respective communication networks.
